(19) United States
(12) Patent Application Publication
(10) Pub. No.: US 2008/0259395 A1
(43) Pub. Date: Oct. 23, 2008

(54) Print Control Device, Printing Device and Computer-Readable Recording Medium

(75) Inventor: Hiromi Mori, Nagoya (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya (JP)

(21) Appl. No.: 12/105,669

(22) Filed: Apr. 18, 2008

(30) Foreign Application Priority Data
Apr. 20, 2007 (JP) 2007-111844

(51) Int. Cl. G06K 15/00

(52) U.S. Cl. 358/1.15

(57) ABSTRACT

A print control device comprises a print data generating unit which generates print data in units of jobs from incoming data. The print data generating unit includes: a layout information generating unit which generates layout information specifying layout in a printable area based on sheet size and the number of pages of the job; a memory that stores an image to be formed on a sheet; and an arrangement unit which generates cascade print data by reducing each page of the job and successively placing and overlaying the reduced pages in the memory corresponding to the sheet size based on the layout information generated by the layout information generating unit.

### CROSS-REFERENCE TO RELATED APPLICATION

This application claims priority under 35 U.S.C. § 119 from Japanese Patent Application No. 2007-111844 filed on Apr. 20, 2007. The entire subject matter of the application is incorporated herein by reference.

### BACKGROUND

1. Technical Field

The present invention relates to a print control device, a printing device and a computer-readable recording medium which are used for printing.

2. Related Art

A computer system capable of printing multiple window forms (e.g., window forms #1-#3) on one shipping slip by successively overlaying the window forms in ascending order of the form number (e.g. #1, #2, #3) while shifting each window form from the previous window form (the so-called “cascade printing”) has been widely known, as described in Japanese Patent Provisional Publication No. HEI 10-49325 (hereinafter, referred to as '325 publication), for example.

The computer system according to '325 publication includes a specified application, a ledger form memory storing ledger forms of a ledger sheet (original) and duplicate ledger sheets which are bound together with the ledger sheet (original), and a ledger data memory storing ledger data of each cell and cell color information (for defining color corresponding to each cell) in regard to each ledger file. According to a program, the CPU of the computer system generates print data based on the ledger forms stored in the ledger form memory and their color information and makes a color printing unit print out the generated print data. Consequently, a window form #1 (shipping slip form read out from the ledger form memory), a window form #2 (delivery slip from) and a window form #3 (receipt slip form) are printed on one output slip in different colors.

As above, the conventional computer system prints out not only the slip form under consideration (e.g. ledger sheet) but also image information, indicating that there exist other slip forms (e.g. duplicate ledger sheets), on one sheet (slip form sheet), by which the user viewing any slip form in consideration (i.e. viewing any slip form sheet) included in a set of slip form sheets can easily recognize the existence of the other slip forms.

### SUMMARY OF THE INVENTION

However, the conventional computer system, in which a specified program generates the print data for cascade printing based on the forms and data stored in the memory and thereafter the printing is carried out by outputting the generated print data to the printing unit, is incapable of executing cascade printing of document files (of forms different from the ledger sheet, for example) in units of pages. Thus, in order to realize the cascade printing of such document files (of forms different from the ledger sheet) in units of pages by use of the conventional computer system, it becomes necessary to generate print data corresponding to the particular forms, or to specially create programs for different forms and install the programs, which takes time, trouble and expense and is unrealistic.

The cascade printing in units of pages is desired in various situations. For example, when a student has prepared a document file (of a document to be distributed) for a presentation on a report at university, if cascade printing of the document in units of pages is possible, it allows both the presenter and the audience to quickly and easily recognize the contents of each page of the document (what is printed on which page of the document), which is highly convenient. Thus, a technology capable of implementing the cascade printing in units of pages irrespective of the forms and according to the intention of the user has been long awaited.

The present invention, which has been made in consideration of the above problems, is advantageous in that a print control device, a printing device and a computer-readable recording medium, capable of realizing the cascade printing in units of pages irrespective of the forms, can be provided.

In accordance with an aspect of the present invention, there is provided a print control device comprising a print data generating unit which generates print data in units of jobs from incoming data. The print data generating unit includes: a layout information generating unit which generates layout information specifying layout in a printable area based on sheet size and the number of pages of the job; a memory that stores an image to be formed on a sheet; and an arrangement unit which generates cascade print data by reducing each page of the job and successively placing and overlaying the reduced pages in the memory corresponding to the sheet size based on the layout information generated by the layout information generating unit.

When the print control device configured as above generates the print data in units of jobs from the incoming data (data read out from a detachable external memory, data received from an application, etc.), the print control device generates the layout information (specifying the layout in the printable area) based on the sheet size and the number of pages of the job, and generates the cascade print data by reducing each page of the job and successively placing and overlaying the reduced pages in the memory (corresponding to the sheet size) based on the layout information. Therefore, multiple pages included in one job can be printed out by the cascade printing in units of pages irrespective of the forms.

In accordance with another aspect of the present invention, there is provided a printing device comprising a print control device including a print data generating unit which generates print data in units of jobs from incoming data. The print data generating unit includes: a layout information generating unit which generates layout information specifying layout in a printable area based on sheet size and the number of pages of the job; and an arrangement unit which generates cascade print data by reducing each page of the job and successively placing and overlaying the reduced pages in the memory corresponding to the sheet size based on the layout information generated by the layout information generating unit.

The above printing device, comprising the aforementioned print control device, achieves the same effects as the print control device (cascade printing in units of pages irrespective of the forms).

In accordance with another aspect of the present invention, there is provided a computer-readable recording medium storing computer-readable instructions that cause a computer to execute a print data generating process of generating print data in units of jobs from incoming data. The print data generating process includes: a layout information generating step of generating layout information specifying layout in a printable area based on sheet size and the number of pages of the job; and an arrangement step of generating cascade print data by reducing each page of the job and successively placing and overlaying the reduced pages in the memory corresponding to the sheet size based on the layout information generated by the layout information generating step.

With the above computer-readable recording medium, effects similar to those of the print control device described above can be achieved, by loading the computer-readable instructions from the recording medium into the computer and making the computer operate according to the instructions.

### BRIEF DESCRIPTION OF THE ACCOMPANYING DRAWINGS

FIG. 1 is a schematic diagram showing a printing system which is formed by connecting a printer to a PC (Personal Computer) including a “print control device” in accordance with a first embodiment of the present invention.

FIG. 2 is a block diagram showing the electrical configuration of the printer shown in FIG. 1.

FIG. 3 is a block diagram showing the electrical configuration of the PC shown in FIG. 1 and the overall composition of a print control device included in the PC.

FIG. 4 is a flow chart showing an example of a print setting screen display control program shown in FIG. 3.

FIG. 5 is a flow chart showing an example of a print control program shown in FIG. 3.

FIG. 6 is a flow chart of a layout information generating process (S26) shown in FIG. 5.

FIG. 7 is a screen image showing an example of a basic setting screen which is displayed on a liquid crystal display of the PC during the execution of the print setting screen display control program of FIG. 4.

FIG. 8 is a screen image showing an example of a list print setting screen which is displayed on the liquid crystal display of the PC during the execution of the print setting screen display control program of FIG. 4.

FIG. 9 is a conceptual diagram explaining layout information which is generated by the layout information generating process (S26) shown in FIG. 5.

FIG. 10 is a schematic diagram showing a first example of the printout of print data generated by the print control program of FIG. 5.

FIG. 11 is a schematic diagram showing a second example of the printout of print data generated by the print control program of FIG. 5.

FIG. 12 is a schematic diagram showing a third example of the printout of print data generated by the print control program of FIG. 5.

FIG. 13 is a block diagram showing the electrical configuration of a printer as an example of a “printing device” in accordance with a second embodiment of the present invention and the overall composition of a print control device included in the printer;

FIG. 14 is a schematic diagram showing an example of a basic setting screen displayed on an LCD unit of the printer shown in FIG. 13.

FIG. 15 is a schematic diagram showing an example of a list setting screen displayed on the LCD unit of the printer.

FIG. 16 is a schematic diagram showing an example of a list mode setting screen displayed on the LCD unit of the printer.

FIG. 17 is a schematic diagram showing an example of a front page setting screen displayed on the LCD unit of the printer.

FIG. 18 is a schematic diagram showing an example of a setting completion screen displayed on the LCD unit of the printer.

### DETAILED DESCRIPTION OF THE EMBODIMENTS

Referring now to the drawings, a description will be given in detail of preferred embodiments in accordance with the present invention.

### Embodiment 1

### Printing System

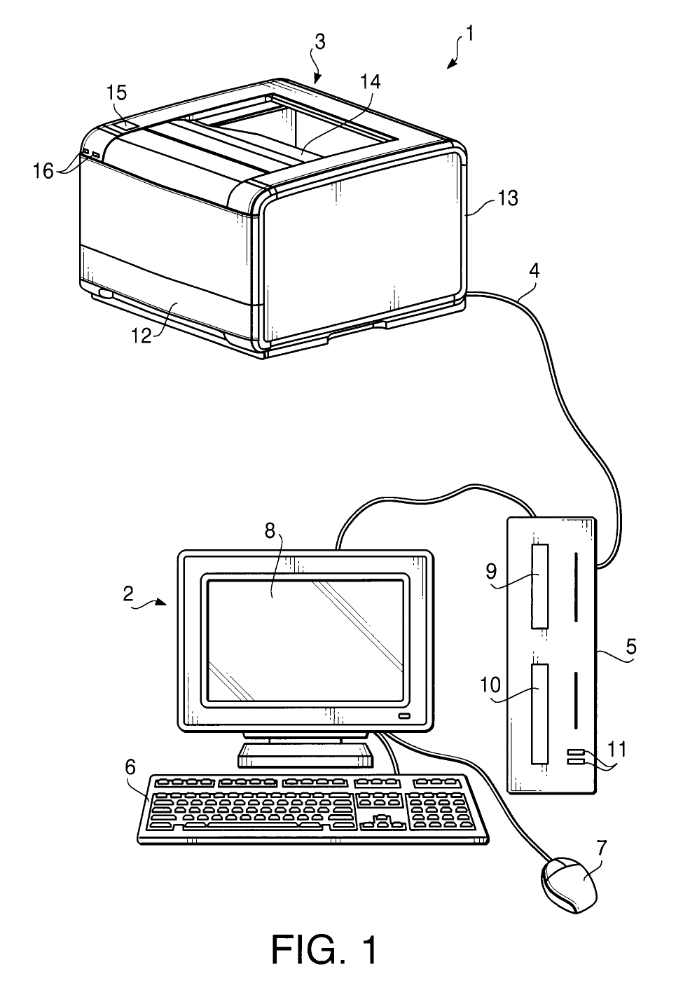

FIG. 1 is a schematic diagram showing a printing system 1 which is formed by connecting a printer 3 to a PC (Personal Computer) 2 including a print control device 40 in accordance with a first embodiment of the present invention.

In the printing system 1, the PC 2 and the printer 3 are connected together by a communication cable 4. The communication cable 4 may either be a cable connecting a PC 2 and a printer 3 in a one-to-one correspondence or a network (e.g. LAN) connecting two or more PCs 2 to a printer 3.

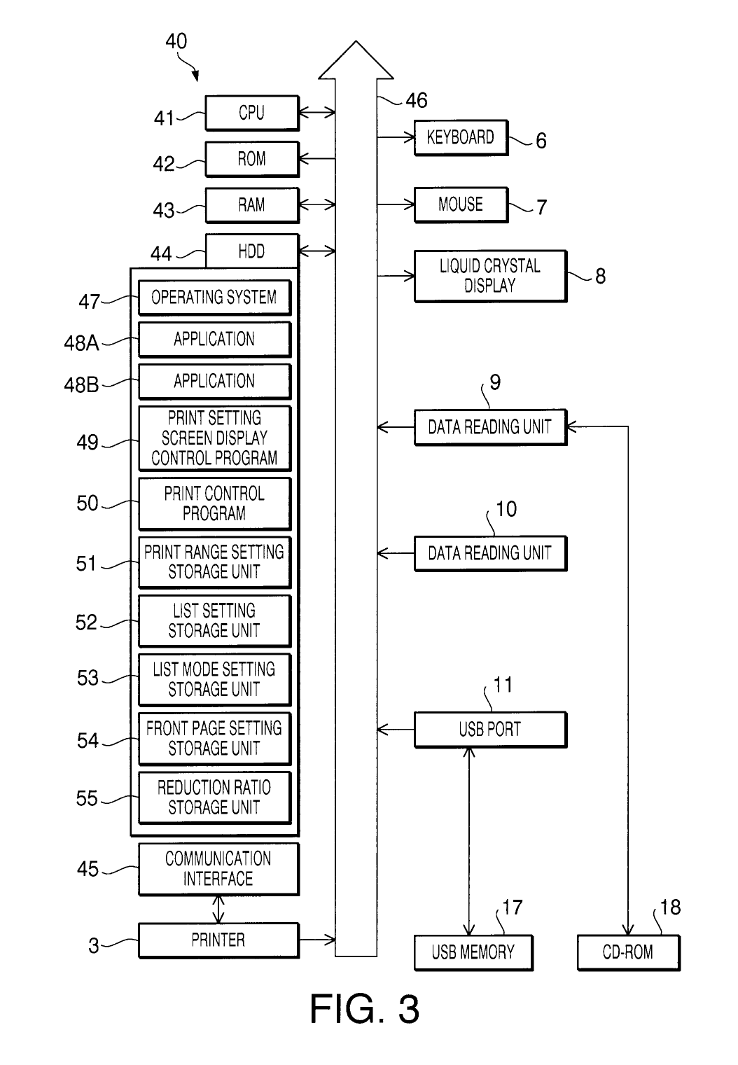

In the PC 2, a keyboard 6 and a mouse 7 to be used for inputting data and a liquid crystal display 8 for displaying data are connected to a control body 5. The control body 5 is equipped with data reading units 9 and 10 for reading out data from record media (e.g. CD-ROM 18, see FIG. 3) set therein and USB ports 11 to which external storage devices (e.g. USB memory 17, see FIG. 3) can be connected.

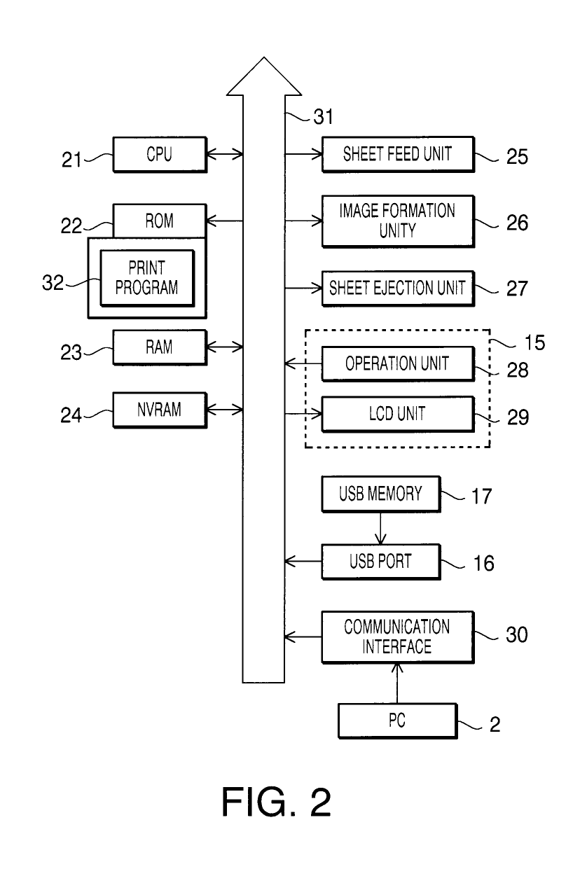

In the printer 3, a detachable sheet feed tray 12 storing sheets to be printed on (paper, transparent sheets, etc.) is inserted into a casing 13 from its front. The top of the casing 13 is provided with an output tray 14, in which the sheets ejected after being printed on are stacked up. On the top of the casing 13, an operation panel 15 is placed beside the output tray 14. The front of the casing 13 is provided with USB ports 16 to which external storage devices (e.g. USB memory 17, see FIG. 2) can be connected.

<Electrical Configuration of Printer>

FIG. 2 is a block diagram showing the electrical configuration of the printer 3 shown in FIG. 1.

The printer 3 includes a CPU (Central Processing Unit) 21, to which a ROM (Read Only Memory) 22, a RAM (Random Access Memory) 23, an NVRAM (NonVolatile RAM) 24, a sheet feed unit 25, an image formation unit 26, a sheet ejection unit 27, the operation panel 15 (including an operation unit 28 and an LCD unit 29), the USB ports 16 and a communication interface 30 are connected by a bus 31. The PC 2 is connected to the communication interface 30. The ROM 22 stores a print program 32 for controlling the printing operation of the printer 3.

In the printer 3 configured as above, upon reception of “print data” from the PC 2 via the communication interface 30 or reception of “print data” read out from the USB memory 17 connected to the USB port 16, the CPU 21 stores the received “print data” in the RAM 23. In response to the print data reception as a trigger, the CPU 21 reads out the print program 32 from the ROM 22 and executes the print program 32, by which a sheet is picked up and fed from the sheet feed tray 12 to the image formation unit 26 by the sheet feed unit 25, the “print data” is printed on the sheet by the image formation unit 26, and the printed sheet is ejected by the sheet ejection unit 27 to the output tray 14.

<Electrical Configuration of PC (Including Print Control Device)>

FIG. 3 is a block diagram showing the electrical configuration of the PC 2 shown in FIG. 1 and the overall composition of the print control device 40 included in the PC 2.

The PC 2 includes a CPU 41, to which a ROM 42, a RAM 43, an HDD (Hard Disk Drive) 44, the keyboard 6, the mouse 7, the liquid crystal display 8, the data reading units 9 and 10, the USB ports 11 and a communication interface 45 are connected by a bus 46.

The ROM 42 stores basic software for the operation of the PC 2.

In the HDD 44, storage areas such as a print range setting storage unit 51, a list setting storage unit 52, a list mode setting storage unit 53, a front page setting storage unit 54 and a reduction ratio storage unit 55 are reserved.

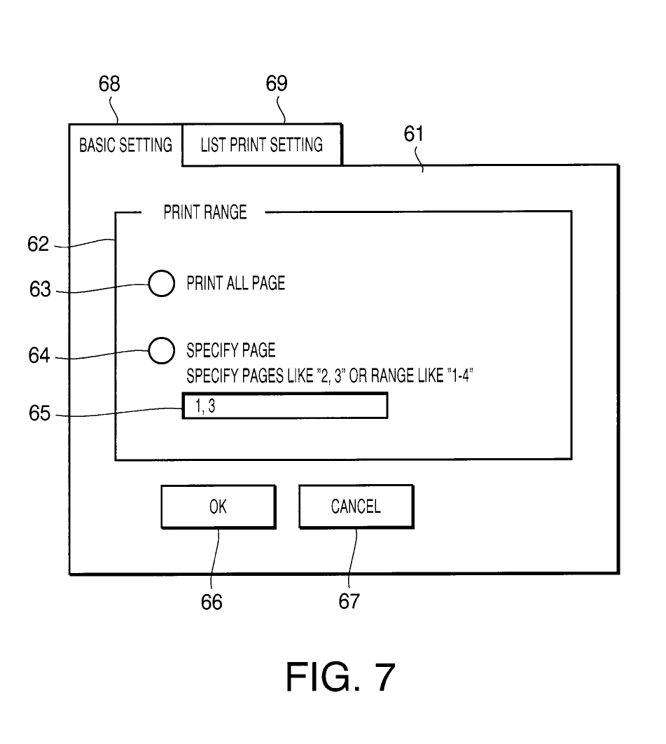

The print range setting storage unit 51 stores a parameter regarding “print range setting” which has been set on a basic setting screen 61 (see FIG. 7) which will be explained later. As the “print range setting” parameter, an all-pages printing parameter specifying “all-pages printing” (printing of all the pages of a job) or a page-specification printing parameter specifying “page-specification printing” (printing of only pages specified for printing from all the pages of a job) is set. The page-specification printing parameter includes a print page specification parameter which concretely specifies the pages to be printed.

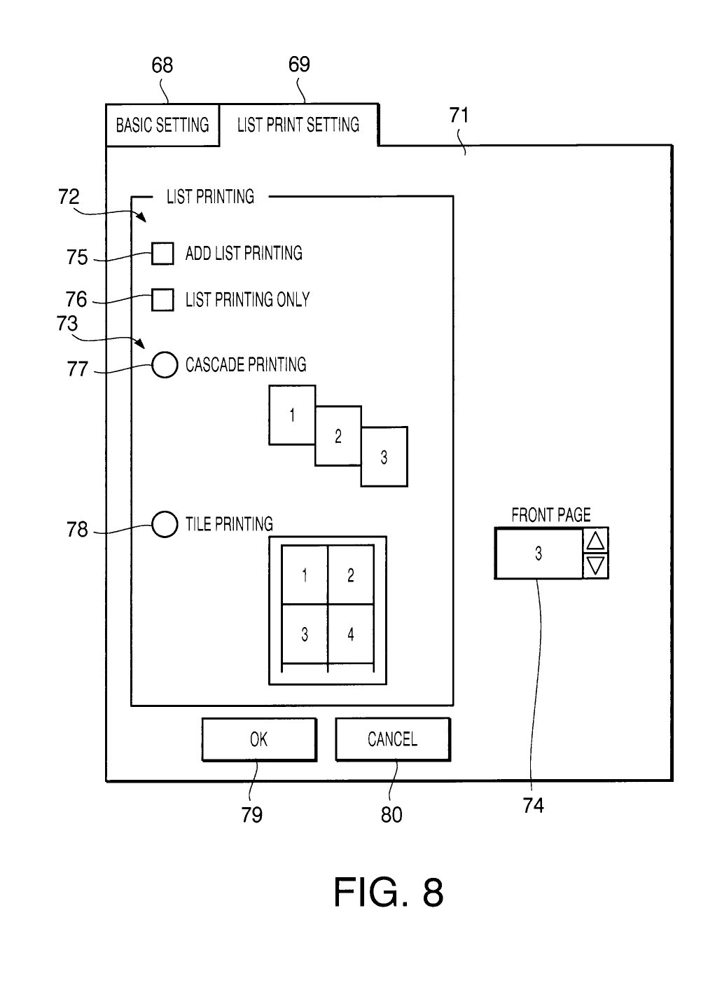

The list setting storage unit 52 stores a parameter regarding “list setting” which has been set on a list print setting screen 71 (see FIG. 8) which will be explained later. As the “list setting” parameter, a normal printing parameter specifying “normal printing” (printing according to “normal print data” in which each page included in a job is placed on one sheet or a list printing parameter specifying “list printing” such as cascade printing and tile printing (printing according to “list print data” in which multiple pages included in a job are placed on one sheet) is set. The list printing parameter can be classified into an add-list parameter for adding the list printing to the normal printing and a list-only parameter for just executing the list printing without executing the normal printing.

The list mode setting storage unit 53 stores a parameter regarding “list mode setting” which has been set on the list print setting screen 71 (see FIG. 8) which will be explained later. As the “list mode setting” parameter, a cascade display parameter (specifying a mode for the cascade printing) or a tile display parameter (specifying a mode for the tile printing) is set.

The front page setting storage unit 54 stores a parameter regarding “front page setting” which has been set on the list print setting screen 71 (see FIG. 8) which will be explained later. The “front page setting” parameter includes a front page specification parameter which specifies the page to be displayed (printed) at the forefront in the cascade printing.

The reduction ratio storage unit 55 stores reduction ratios to be used for reducing each page of the job (in order to arrange the reduced pages on one sheet) when the “list print data” is generated. The reduction ratios include a horizontal reduction ratio Kx to be used for reducing the sheet (page) in the horizontal direction and a vertical reduction ratio Ky to be used for reducing the sheet (page) in the vertical direction. In the first embodiment, the reduction ratios are preset separately for the cascade printing and the tile printing, as coefficients corresponding to the number of pages included in the job.

The HDD 44 stores various programs such as an operating system 47 and applications 48A and 48B. Further, when a printer driver is installed in the PC 2 from a CD-ROM 18 set in the data reading unit 9, for example, a print setting screen display control program 49 and a print control program 50 included in the printer driver are stored in the HDD 44.

The print setting screen display control program 49 is a program for displaying print setting screens (including the basic setting screen 61 shown in FIG. 7 and the list print setting screen 71 shown in FIG. 8), to be used for setting print conditions (including the parameters regarding the aforementioned “print range setting”, “list setting”, “list mode setting” and “front page setting”), on the liquid crystal display 8.

The print control program 50 is a program for generating “print data” for each job from “incoming data” (received from the application 48A, the application 48B or the USB memory 17, for example) according to the print conditions (including the parameters regarding the “print range setting”, “list setting”, “list mode setting” and “front page setting”) which have been set on the print setting screens (see FIGS. 7 and 8, for example) and outputting the generated print data to the printer 3.

Concrete operation of the print setting screen display control program 49 and the print control program 50 will be described later.

Incidentally, the print control device 40 in the first embodiment is formed by the CPU 41, the RAM 43, the HDD 44, the storage units in the HDD 44 (the print range setting storage unit 51, the list setting storage unit 52, the list mode setting storage unit 53, the front page setting storage unit 54 and the reduction ratio storage unit 55), and the print setting screen display control program 49 and the print control program 50 stored in the HDD 44.

<Operation>

Next, the printing of the “print data” will be described in detail.

1. Setting of Print Conditions

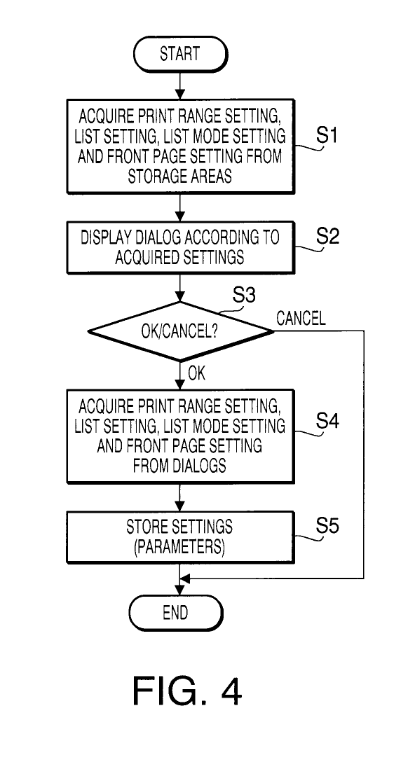

The user of the PC 2 can call up a “print setting menu” by operating the mouse 7, for example, and set the print conditions (for making the printer 3 execute the printing of the “print data”) on the print setting screens. FIG. 4 is a flow chart showing an example of the print setting screen display control program 49 shown in FIG. 3, which is executed by the CPU 41 of the PC 2. FIG. 7 is a screen image showing an example of the basic setting screen 61 displayed on the liquid crystal display 8 of the PC 2 during the execution of the print setting screen display control program 49 of FIG. 4. FIG. 8 is a screen image showing an example of the list print setting screen 71 displayed on the liquid crystal display 8 of the PC 2 during the execution of the print setting screen display control program 49 of FIG. 4.

When the “print setting menu” is called up by the user by operating the mouse 7, for example, the CPU 41 of the PC 2 loads the print setting screen display control program 49 from the HDD 44 into the RAM 43 and executes the program 49.

In the first step S1 of the print setting screen display control program 49 of FIG. 4, the CPU 41 reads out the parameters regarding the “print range setting”, “list setting”, “list mode setting” and “front page setting” from the print range setting storage unit 51, the list setting storage unit 52, the list mode setting storage unit 53 and the front page setting storage unit 54 of the HDD 44 and stores the parameters in the RAM 43. When the print setting screen display control program 49 is executed for the first time, initial values of the parameters are stored in the RAM 43, otherwise parameters already set during the preceding execution of the print setting screen display control program 49 are read out from the storage units 51-54 and stored in the RAM 43.

In step S2, the CPU 41 displays the dialogs (basic setting screen 61, list print setting screen 71) shown in FIGS. 7 and 8 on the liquid crystal display 8 based on the parameters acquired in S1.

The basic setting screen 61 shown in FIG. 7 includes a print range setting input window 62. The print range setting input window 62 includes an all-pages printing radio button 63 for selecting the all-pages printing and setting the all-pages printing parameter in the print range setting storage unit 51, a page-specification printing radio button 64 for selecting the page-specification printing (the printing of specified pages only) and setting the page-specification printing parameter in the print range setting storage unit 51, and a print page specification window 65 for setting the print page specification parameter (specifying the pages to be printed) in the print range setting storage unit 51 when the page-specification printing radio button 64 has been selected. Further, an OK button 66 for specifying the completion of the print condition setting and a CANCEL button 67 for specifying the cancellation of the print condition setting are placed under the print range setting input window 62.

The basic setting screen 61 has a tag 68 for selecting and viewing the basic setting screen 61 shown in FIG. 7 and a tag 69 for selecting and viewing the list print setting screen 71 shown in FIG. 8. When the list printing is necessary, the user selects the tag 69 (by clicking on the tag with the mouse 7, for example) and sets the list print conditions on the list print setting screen 71 shown in FIG. 8.

The list print setting screen 71 shown in FIG. 8 includes a list setting input window 72 for setting the normal printing parameter or the list printing parameter in the list setting storage unit 52, a list mode setting input window 73 for setting the cascade display parameter or the tile display parameter in the list mode setting storage unit 53, and a front page setting input window 74 for setting the front page specification parameter in the front page setting storage unit 54.

The list setting input window 72 includes an add-list check box 75 for setting the add-list parameter in the list setting storage unit 52 and a list-only check box 76 for setting the list-only parameter in the list setting storage unit 52.

The list mode setting input window 73 includes a cascade printing radio button 77 for setting the cascade display parameter in the list mode setting storage unit 53 and a tile printing radio button 78 for setting the tile display parameter in the list mode setting storage unit 53.

The front page setting input window 74 is used for specifying a page (one of the pages included in one job) that should be placed at the forefront of one sheet in the cascade printing.

The previously set parameters (regarding the “print range setting”, “list setting”, “list mode setting” and “front page setting”) acquired in the step S1 are automatically incorporated in the basic setting screen 61 and the list print setting screen 71, which saves the user from the need of manual input.

Further, an OK button 79 for completing the setting of the list print conditions and a CANCEL button 80 for canceling the setting are placed at the bottom of the list print setting screen 71. When either the OK button 79 or the CANCEL button 80 is selected, the list print setting screen 71 shown in FIG. 8 is erased and the basic setting screen 61 shown in FIG. 7 is displayed.

In step S3, the CPU 41 judges whether the OK button 66 or the CANCEL button 67 on the basic setting screen 61 shown in FIG. 7 has been clicked. When the CANCEL button 67 has been clicked (S3: CANCEL), the CPU 41 immediately ends the process of FIG. 4 without rewriting the print conditions.

When the OK button 66 has been clicked (S3: OK), the CPU 41 advances to step S4 and acquires the “print range setting” parameter which has been set on the dialog of FIG. 7 (basic setting screen 61) while also acquiring the parameters regarding the “list setting”, “list mode setting” and “front page setting” which have been set on the dialog of FIG. 8 (list print setting screen 71) on the assumption that the OK button 79 on the dialog of FIG. 8 has been clicked.

In step S5, the CPU 41 rewrites the print conditions by overwriting the print range setting storage unit 51, the list setting storage unit 52, the list mode setting storage unit 53 and the front page setting storage unit 54 with the parameters acquired in the step S4, by which the process of FIG. 4 is ended.

2. Generation and Output of Print Data

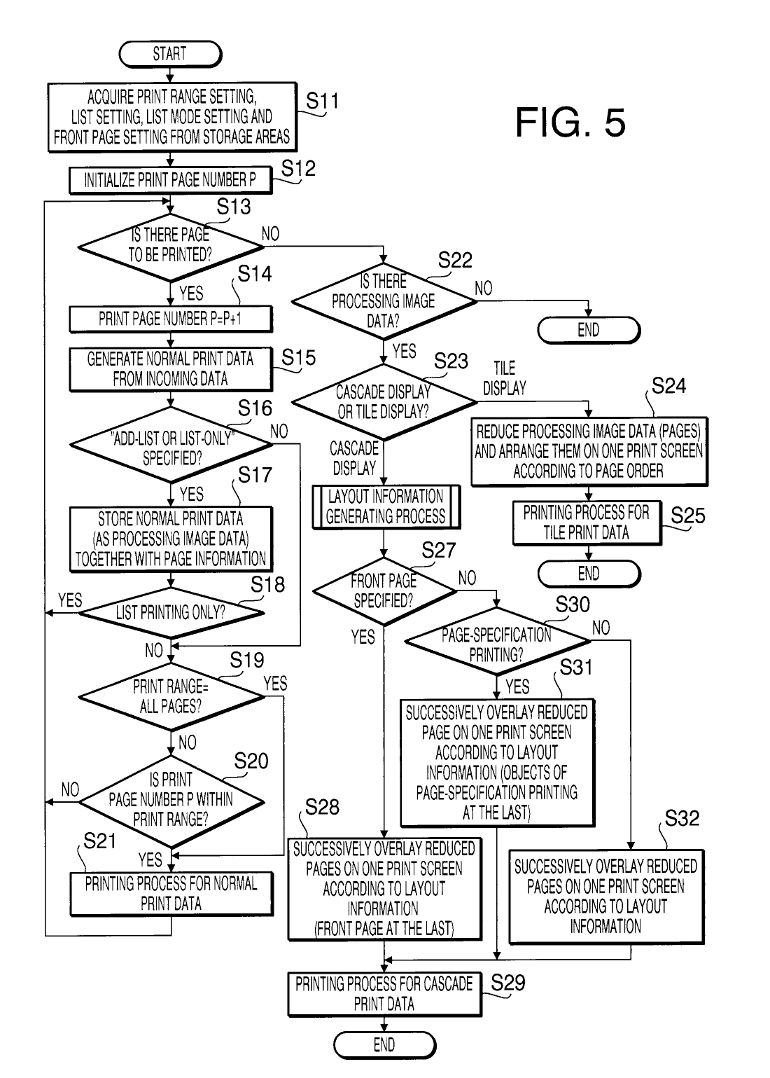

FIG. 5 is a flow chart showing an example of the print control program 50 shown in FIG. 3.

The CPU 41 of the PC 2 reads out the print control program 50 of FIG. 5 from the HDD 44 and executes the program 50 in response to a trigger such as the user's input of a print instruction (for making the printer 3 print out “print data”) through the keyboard 6 or the mouse 7 during the execution of the application 48A.

In the first step S11 of the print control program 50 of FIG. 5, the CPU 41 acquires the parameters regarding the “print range setting”, “list setting”, “list mode setting” and “front page setting” by reading out the parameters from the print range setting storage unit 51, the list setting storage unit 52, the list mode setting storage unit 53 and the front page setting storage unit 54 of the HDD 44 and copying them to the RAM 43.

In step S12, the CPU 41 initializes a “print page number P” (the page number of the page to be printed) to 0, by which the print page number P in regard to the previous “incoming data” is cleared.

In step S13, the CPU 41 judges whether or not there exists a page to be printed. The judgment on the presence/absence of a page to be printed is made based on whether there exists “incoming data” in the RAM 43 or not. For example, in cases where the application 48A outputs the “incoming data” to the print control program 50 in units of pages (page by page), the CPU 41 judges that there exists a page to be printed (S13: YES) since the CPU 41 has already stored “incoming data” for one page (received from the application 48A) in the RAM 43.

In step S14, the CPU 41 increments the print page number P by 1 and thereby recognizes that the CPU 41 is starting a printing process for the current page (the first page in the first execution of S14).

In step S15, the CPU 41 generates the “normal print data” of the current page (the first page in the first execution of S15) by reading out the “incoming data” from the RAM 43 and placing the “incoming data” on one sheet.

In step S16, the CPU 41 judges whether or not the “list setting” parameter acquired in S11 is either the add-list parameter or the list-only parameter set in the list setting input window 72 shown in FIG. 8. In other words, the CPU 41 judges which of the normal printing parameter or the list printing parameter has been set in the list setting storage unit 52. When neither the add-list parameter nor the list-only parameter has been set as the “list setting” parameter (S16: NO), the CPU 41 judges that the normal printing parameter has been set in the list setting storage unit 52 and advances to step S19.

On the other hand, when either the add-list parameter or the list-only parameter has been set as the “list setting” parameter (S16: YES), the CPU 41 judges that the list printing parameter has been set in the list setting storage unit 52 and advances to step S17. In the step S17, the CPU 41 stores the “normal print data” generated in S15 in the RAM 43 as “processing image data” (image data to be processed) together with page information. Incidentally, the “processing image data” can be obtained either by just copying the “normal print data” or by processing the “normal print data” to save as much storage capacity of the RAM 43 as possible (reducing the resolution of the “normal print data”, compressing the “normal print data”, etc.). The storing of the “processing image data” in the RAM 43 together with the page information makes it possible to easily recognize (“normal print data” of) which page corresponds to the “processing image data”.

In step S18, the CPU 41 judges whether only the list printing is necessary (requested by the user) or not by referring to the “list setting” parameter acquired in S11. When the list-only parameter has been set as the “list setting” parameter, that is, when only the list printing is necessary (S18: YES), the CPU 41 returns to the step S13 (since the normal printing is unnecessary) and judges whether there exists “incoming data” of the next page or not. On the other hand, when the list-only parameter has not been set as the “list setting” parameter (S18: NO), the CPU 41 advances to step S19 so as to execute the list printing in addition to the normal printing.

In the step S19, the CPU 41 judges whether the print range is all the pages or not by referring to the “print range setting” parameter acquired in S11, that is, the CPU 41 judges which of the all-pages printing or the page-specification printing is intended for the normal printing. When the all-pages printing parameter (specified in the print range setting input window 62 shown in FIG. 7) has been set as the “print range setting” parameter, that is, when the print range is all the pages (S19: YES), the CPU 41 advances to step S21.

On the other hand, when the page-specification printing parameter (specified in the print range setting input window 62 shown in FIG. 7) has been set as the “print range setting” parameter, that is, when the print range is not all the pages (S19: NO), the CPU 41 advances to step S20 and judges whether or not the current print page number P is within the “print range setting” (print range) specified by the print page specification parameter which has been inputted and set in the print page specification window 65 shown in FIG. 7. When the print page number P is not included in the “print range setting” (print range) specified by the print page specification parameter (S20: NO), the CPU 41 returns to the step S13 without executing the printing process for the “normal print data” since the currently processed page having the current print page number P is not an object of the page-specification printing. When the print page number P is within the “print range setting” (S20: YES), the CPU 41 advances to the step S21 since the currently processed page is an object of the page-specification printing.

In the step S21, the CPU 41 executes the printing process for the “normal print data” generated in S15 by converting the “normal print data” into PDL data and outputting the PDL data to the printer 3 via the communication interface 45. Thereafter, the process returns to the step S13.

As above, in the case of the all-pages printing, the CPU 41 generates the “normal print data”, converts the “normal print data” into PDL data and outputs the PDL data to the printer 3 via the communication interface 45 upon each reception of the “incoming data” (of each page included in one job) from the application 48A, by repeatedly executing the sequence of S13-S21.

Meanwhile, in the case of the page-specification printing, the CPU 41 similarly generates the “normal print data” upon each reception of the “incoming data” (of each page included in one job) from the application 48A by repeatedly executing the sequence of S13-S21. However, the CPU 41 carries out the conversion of the “normal print data” into PDL data and the outputting of the PDL data to the printer 3 via the communication interface 45 only when the “incoming data” is of a page as an object of the page-specification printing. In other words, in the page-specification printing, the CPU 41 successively converts the “normal print data” of pages as the objects of the page-specification printing into PDL data and outputs the PDL data to the printer 3 via the communication interface 45 by repeatedly executing the sequence of S13-S21.

By the repetition of the sequence of S13-S21, the CPU 41 accumulates the “processing image data” of the print pages (pages to be printed) in the RAM 43 while successively outputting the “normal print data” of the P-th pages (P: print page number) to the printer 3 as needed. When an end mark is found in the “incoming data” received from the application 48A, the CPU 41 judges that there exists no more page to be printed (S13: NO) and checks whether or not the “processing image data” has been stored in the RAM 43 (S22). When no “processing image data” has been stored in the RAM 43 (S22: NO), the CPU 41 immediately ends the process of FIG. 5 since the list printing is unnecessary.

On the other hand, when the “processing image data” has been stored in the RAM 43 by S17 (S22: YES), the CPU 41 judges whether the “processing image data” should be displayed (printed) in the cascade display (cascade printing) or in the tile display (tile printing) by referring to the “list mode setting” parameter (S23). When the tile display parameter has been set as the “list mode setting” parameter, that is, when the “processing image data” should be displayed in the tile display (S23: TILE DISPLAY), the CPU 41 advances to step S24. In the step S24, the CPU 41 reduces the size of each piece of “processing image data” (corresponding to a page) so that all pieces of “processing image data” can be arranged on one sheet without overlapping with each other, and successively arranges all of the pieces of “processing image data” on the one sheet according to the page order, by which “tile print data” is generated. Subsequently, the CPU 41 executes the printing process for the generated “tile print data” (S25) by converting the “tile print data” into PDL data and outputting the PDL data to the printer 3 via the communication interface 45.

On the other hand, when the cascade display parameter has been set as the “list mode setting” parameter, that is, when the “processing image data” should be displayed in the cascade display (S23: CASCADE DISPLAY), the CPU 41 executes a layout information generating process (S26).

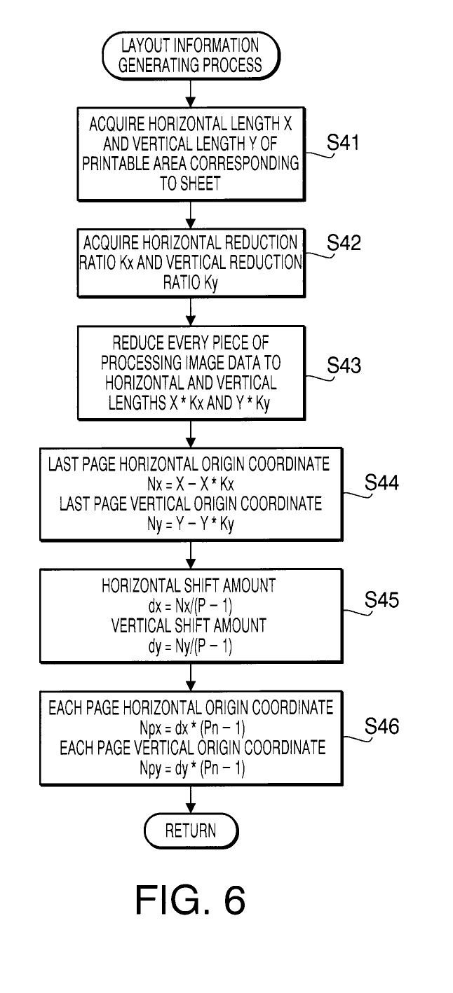

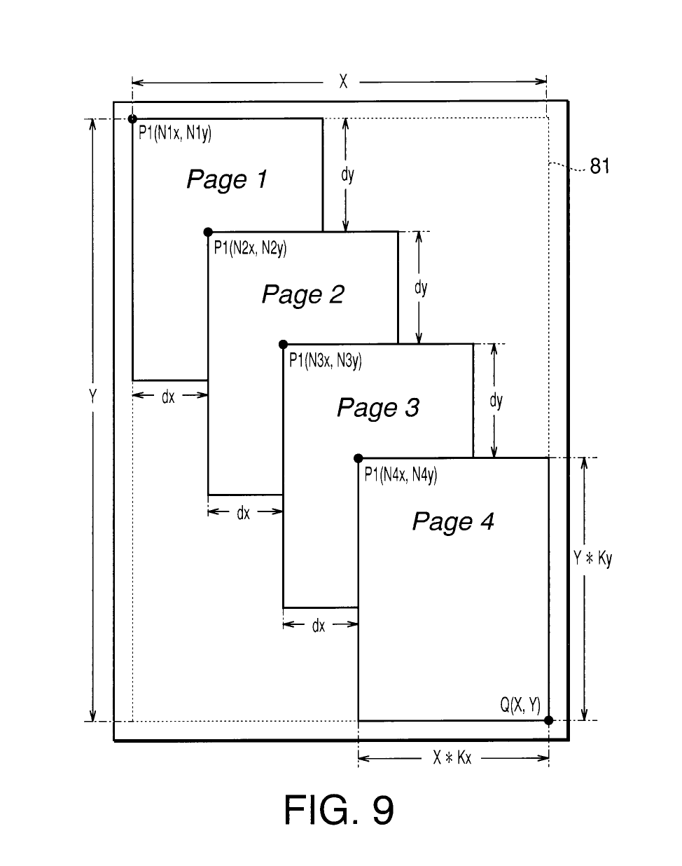

FIG. 6 is a flow chart of the layout information generating process (S26) shown in FIG. 5. FIG. 9 is a conceptual diagram explaining layout information which is generated by the layout information generating process (S26) shown in FIG. 5.

In the first step S41 of the layout information generating process of FIG. 6, the CPU 41 acquires horizontal length X and vertical length Y of a printable area 81 (corresponding to the sheet) indicated by dotted lines in FIG. 9 and thereby recognizes the area of one sheet.

In step S42, the CPU 41 acquires a horizontal reduction ratio Kx and a vertical reduction ratio Ky by reading out the ratios Kx and Ky from the reduction ratio storage unit 55 (using the number of pieces of “processing image data” (i.e. the number of pages of the job) as an argument) and copying them to the RAM 43.

In step S43, the CPU 41 reduces every piece of “processing image data” so that its horizontal length equals the product of the horizontal length X of the printable area 81 and the horizontal reduction ratio Kx acquired in S42 and its vertical length equals the product of the vertical length Y of the printable area 81 and the vertical reduction ratio Ky acquired in S42, by which all pieces of “processing image data” are reduced to the same size.

In step S44, the CPU 41 calculates a last page horizontal origin coordinate Nx and a last page vertical origin coordinate Ny (i.e. coordinates (Nx, Ny) of the origin (upper left corner) of the last page). For example, the upper left corner of the printable area 81 (where the upper edge and the left edge of the printable area 81 intersect with each other) is defined as the origin (0, 0) of the coordinate system, and a horizontal origin coordinate N1x and a vertical origin coordinate N1y of the first page are set at 0 and 0, that is, the origin (upper left corner) of the first page is set at the origin (0, 0) of the coordinate system. In this case, the setting of the positions of intermediate pages (between the first page and the last page) is facilitated by obtaining the last page horizontal origin coordinate Nx and the last page vertical origin coordinate Ny. The last page is placed so that its lower right corner is at the lower right corner Q(X, Y) of the printable area 81 (where the lower edge and the right edge of the printable area 81 intersect with each other). Therefore, the last page horizontal origin coordinate Nx can be obtained by subtracting the horizontal length X*Kx of the “processing image data” reduced in S43 from the horizontal length X of the printable area 81 (Nx=X−X*Kx), and the last page vertical origin coordinate Ny can be obtained by subtracting the vertical length Y*Ky of the “processing image data” reduced in S43 from the vertical length Y of the printable area 81 (Ny=Y−Y*Ky).

In step S45, the CPU 41 calculates a horizontal shift amount dx and a vertical shift amount dy to be used for successively placing (shifting) the pieces of “processing image data” (obtained by reducing the pages of one job) in the printable area 81. Since (the origins of) the intermediate pages between the first page and the last page have to be evenly arranged in the free space between the origin (0, 0) and the last page origin (Nx, Ny), the horizontal shift amount dx is obtained by dividing the last page horizontal origin coordinate Nx (obtained in S44) by the print page number P minus 1 (dx=Nx/(P−1)), and the vertical shift amount dy is obtained by dividing the last page vertical origin coordinate Ny (obtained in S44) by the print page number P minus 1 (dy=Ny/(P−1)).

In step S46, the CPU 41 calculates a horizontal origin coordinate Npx and a vertical origin coordinate Npy of each page included in the job with respect to the origin (0, 0) of the coordinate system. The horizontal origin coordinate Npx of each page is obtained by multiplying the horizontal shift amount dx (obtained in S45) by the page number Pn (of the page) minus 1 (Npx=dx*(Pn−1)). Similarly, the vertical origin coordinate Npy of each page is obtained by multiplying the vertical shift amount dy (obtained in S45) by the page number Pn (of the page) minus 1 (Npy=dy*(Pn−1)).

After generating the above “layout information” including the reduction ratios Kx and Ky, the last page origin (Nx, Ny), the horizontal shift amount dx, the vertical shift amount dy and the origin (Npx, Npy) of each page, the CPU 41 ends the layout information generating process of FIG. 6 (S26 in FIG. 5) and advances to step S27 in FIG. 5.

In step the S27, the CPU 41 judges whether the front page has been specified or not by referring to the “front page setting” parameter acquired in S11.

When the front page specification parameter (specified in the front page setting input window 74 shown in FIG. 8) has been set as the “front page setting” parameter, that is, when the front page has been specified (S27: YES), the CPU 41 advances to step S28.

In the step S28, the CPU 41 reduces the “processing image data” of each page according to the layout information (reduction ratios Kx and Ky) generated in S26, and arranges the pages (reduced image data) on one sheet while horizontally and vertically shifting each page from the previous page by the horizontal and vertical shift amounts dx and dy, by successively placing (overlaying) the pages (from the first page to the last page) while positioning (the upper left corner of) each page at the origin (Npx, Npy) of the page. Incidentally, the “front page” specified by the “front page setting” parameter (front page specification parameter) acquired in S11 is overlaid last. By the step S28, “cascade print data”, placing the page specified by the user (front page) at the forefront, is generated irrespective of whether the printing process has actually been carried out for the “normal print data” or not. Thereafter, the CPU 41 advances to step S29 and executes the printing process for the “cascade print data” generated in S28, by converting the “cascade print data” into PDL data and outputting the PDL data to the printer 3 via the communication interface 45.

On the other hand, when no front page specification parameter has been set as the “front page setting” parameter, that is, when no front page has been specified (S27: NO), the CPU 41 advances to step S30.

In the step S30, the CPU 41 judges whether the page-specification printing has been executed or not by referring to the “print range setting” parameter acquired in S11.

When the page-specification printing parameter has been set as the “print range setting” parameter, that is, when the page-specification printing has been executed (S30: YES), the CPU 41 advances to step S31.

In the step S31, the CPU 41 reduces the “processing image data” of each page according to the layout information (reduction ratios Kx and Ky) generated in S26, and arranges the pages (reduced image data) on one sheet while horizontally and vertically shifting each page from the previous page by the horizontal and vertical shift amounts dx and dy, by successively placing (overlaying) the pages (from the first page to the last page) while positioning (the upper left corner of) each page at the origin (Npx, Npy) of the page. In the step S31, however, the successive placing/overlaying of the pages specified by the print page specification parameter (“print range setting”) acquired in S11 (i.e. the objects of the page-specification printing) is carried out after the successive placing/overlaying of the other pages not specified by the print page specification parameter. By the step S31, “cascade print data”, placing the pages specified by the print page specification parameter at the front and the other pages (not specified by the print page specification parameter) at the rear, is generated. Thereafter, the CPU 41 advances to the step S29 and executes the printing process for the “cascade print data” generated in S31, by converting the “cascade print data” into PDL data and outputting the PDL data to the printer 3 via the communication interface 45.

On the other hand, when the page-specification printing parameter has not been set as the “print range setting” parameter, that is, when the page-specification printing has not been executed (S30: NO), the CPU 41 advances to step S32.

In the step S32, the CPU 41 reduces the “processing image data” of each page according to the layout information (reduction ratios Kx and Ky) generated in S26, and arranges the pages (reduced image data) on one sheet while horizontally and vertically shifting each page from the previous page by the horizontal and vertical shift amounts dx and dy, by successively placing (overlaying) the pages (from the first page to the last page) while positioning (the upper left corner of) each page at the origin (Npx, Npy) of the page. In this case, the last page is overlaid last. By the step S32, “cascade print data” of the pages included in the job is generated. Thereafter, the CPU 41 advances to the step S29 and executes the printing process for the “cascade print data” generated in S32, by converting the “cascade print data” into PDL data and outputting the PDL data to the printer 3 via the communication interface 45.

3. Printing of Print Data

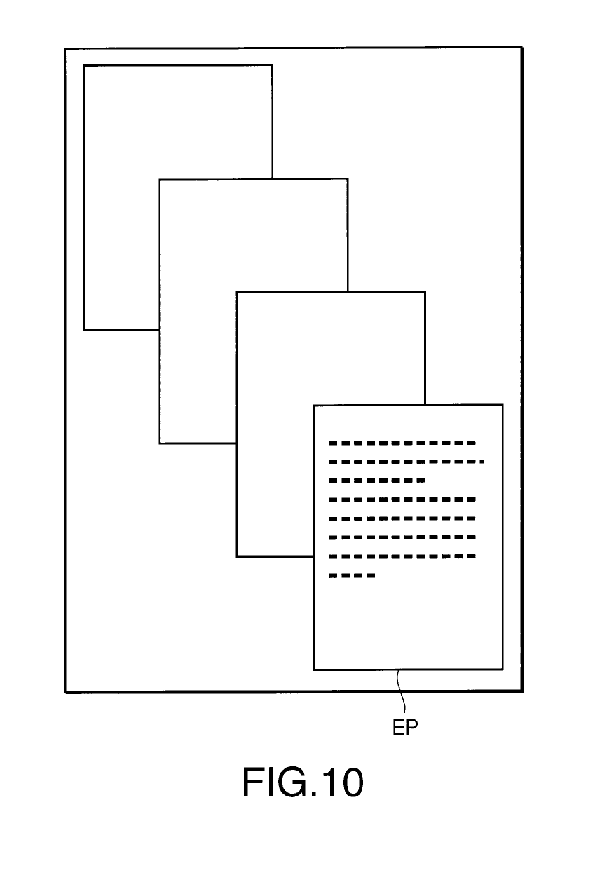

Upon receiving the “print data” (PDL data) from the PC 2, the printer 3 loads the print program 32 from the ROM 22 into the RAM 23 and executes the print program 32, that is, carries out the printing of the received “print data” on a sheet (e.g. paper). FIGS. 10-12 are schematic diagrams showing examples of the printout of the “print data” generated by the print control program 50 of FIG. 5.

Specifically, the printer 3 first executes the normal printing (one page on one sheet) for all the pages (when the all-pages printing has been specified by the user) or for the specified pages (when the page-specification printing has been specified by the user), and thereafter receives the “cascade print data” or “tile print data” from the PC 2 and executes the list printing (cascade printing or tile printing).

When “cascade print data” generated without specifying the front page or the pages for the page-specification printing is received from the PC 2 (S27: N0, S30: N0, S32 in FIG. 5), a printout like the one shown in FIG. 10 is obtained by the printing of the “cascade print data” by the printer 3, in which the last page EP is placed at the forefront of the pages included in one job.

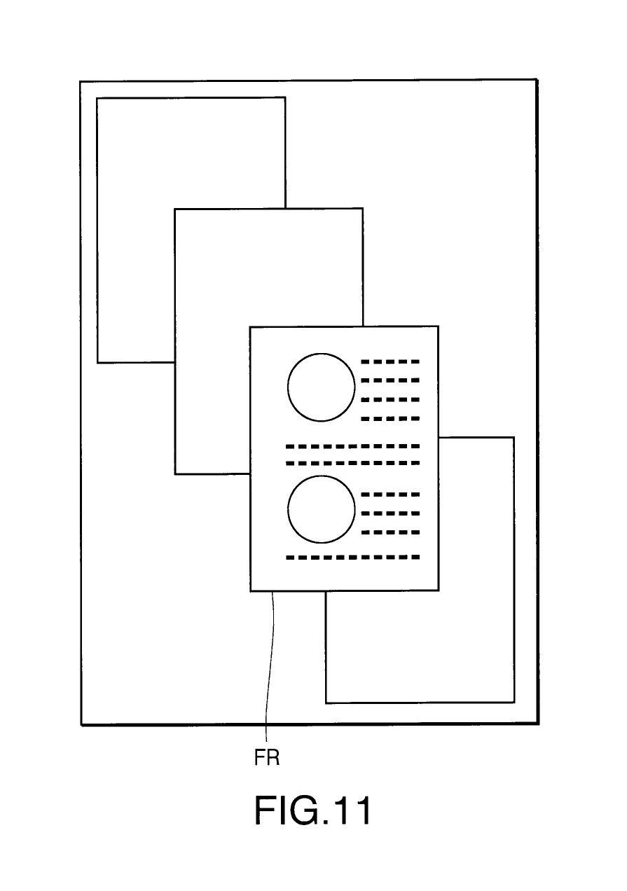

When “cascade print data” generated specifying the front page is received from the PC 2 (S27: N0, S28 in FIG. 5), a printout like the one shown in FIG. 11 is obtained by the printing of the “cascade print data” by the printer 3, in which the front page FR specified in the front page setting input window 74 of the list print setting screen 71 shown in FIG. 8 (page 3 in the example of FIGS. 8 and 11) is placed at the forefront of the pages included in one job.

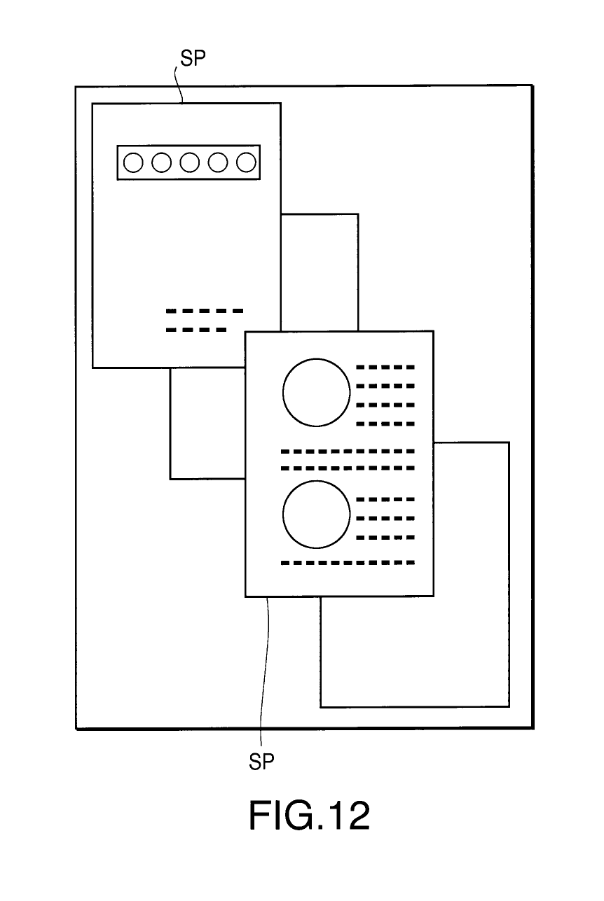

When “cascade print data” generated specifying the pages for the page-specification printing is received from the PC 2 (S27: NO, S30: YES, S31 in FIG. 5), a printout like the one shown in FIG. 12 is obtained by the printing of the “cascade print data” by the printer 3, in which pages SP specified in the print page specification window 65 of the basic setting screen 61 shown in FIG. 7 (pages 1 and 3 in the example of FIGS. 7 and 12) are placed at the front of the pages included in one job.

As described above, the print control device 40 and the print control program 50 in accordance with the first embodiment of the present invention achieves the following effects. When the “print data” for each page is generated from the “incoming data” received from the application 48A, for example, the layout information specifying the layout of the pages in the printable area 81 is generated based on the sheet size and the number of pages of the job, and the “cascade print data” is generated by reducing the pages (“processing image data”) of the job and successively placing and overlaying the reduced pages on one sheet corresponding to the sheet size based on the layout information (S26-S32 in FIG. 5). With the “cascade print data” generated as above, the printer 3 is capable of carrying out the cascade printing (of pages included in one job) in units of pages (see FIGS. 10-12).

Specifically, even when “incoming data” made up of two or more pages are generated by the applications 48A and 48B employing different forms, the print control device 40 and the print control program 50 of the first embodiment are capable of generating “cascade print data” in which pages of one job included in the “incoming data” (received from the applications 48A and 48B) are reduced and successively placed (overlaid). Therefore, the generation of the “cascade print data” and the execution of the cascade printing are possible without the need of generating “print data” according to the form of each of the applications 48A and 48B, or specially creating programs equipped with the forms of the applications 48A and 48B and installing the programs in the PC 2.

The print control device 40 of the first embodiment reduces the pages included in one job according to the horizontal reduction ratio Kx and the vertical reduction ratio Ky included in the layout information and successively places and overlays the reduced pages on one sheet according to the horizontal shift amount dx and the vertical shift amount dy included in the layout information (see S28, S31, S32 in FIG. 5, FIG. 9). Therefore, the pages included in the job can easily be arranged on the sheet by successively shifting the pages in an oblique direction.

The print control device 40 of the first embodiment is capable of generating the “cascade print data” while placing (overlaying) the front page, specified in the front page setting input window 74 of the list print setting screen 71 from the pages of one job (e.g. page 3 of a job including four pages), at the last (see S27: YES, S28 in FIG. 5, FIG. 8). Therefore, the cascade printing can be carried out while placing the front page intended by the user (e.g. page 3 of a job including four pages) at the forefront of the pages included in the job (see FIG. 11).

When a job is made up of four pages and pages 1 and 3 of the job are specified in the print page specification window 65 of the basic setting screen 61, for example, and the print control device 40 of the first embodiment generates “normal print data” (one page on one sheet) for each of pages 1 and 3, the print control device 40 also generates the “cascade print data” by successively placing (overlaying) pages 2 and 4 first and thereafter successively placing (overlaying) pages 1 and 3 (see S16: YES, S17, S18: N0, S19: N0, S20: YES, S21, S22: YES, S23: CASCADE DISPLAY, S26, S27: N0, S30: YES, S31 in FIG. 5, FIG. 7), by which two printouts as the result of the normal printing of pages 1 and 3 and a printout as the result of the cascade printing placing pages 2 and 4 at the back and pages 1 and 3 at the front (see FIG. 12) are obtained. Thus, the user viewing the cascade printout can easily recognize the positions (or positional relationship) of the printouts of pages 1 and 3 in the whole job.

The print control device 40 of the first embodiment is capable of selecting the “normal printing” and/or the “cascade printing” depending on whether or not the add-list check box 75 or the list-only check box 76 in the list setting input window 72 has been checked and whether or not the cascade printing radio button 77 in the list mode setting input window 73 has been selected (see FIG. 8). Specifically, when neither the add-list check box 75 nor the list-only check box 76 in the list setting input window 72 (see FIG. 8) has been checked, only the normal printing is executed according to “normal print data” (in which one page is placed on one sheet). When either the add-list check box 75 or the list-only check box 76 in the list setting input window 72 has been checked and the cascade printing radio button 77 in the list mode setting input window 73 (see FIG. 8) has been selected, the cascade printing (successively placing and overlaying the pages included in one job on one sheet while shifting each page from the previous page) is executed. In this case, the cascade printing is executed in addition to the normal printing when the add-list check box 75 has been checked, while only the cascade printing is executed (without executing the normal printing) when the list-only check box 76 has been checked. Thus, the print control device 40 of the first embodiment, letting the user select whether to execute the cascade printing or not on the list print setting screen 71 shown in FIG. 8, is capable of executing the cascade printing according to the intention of the user.

### Embodiment 2

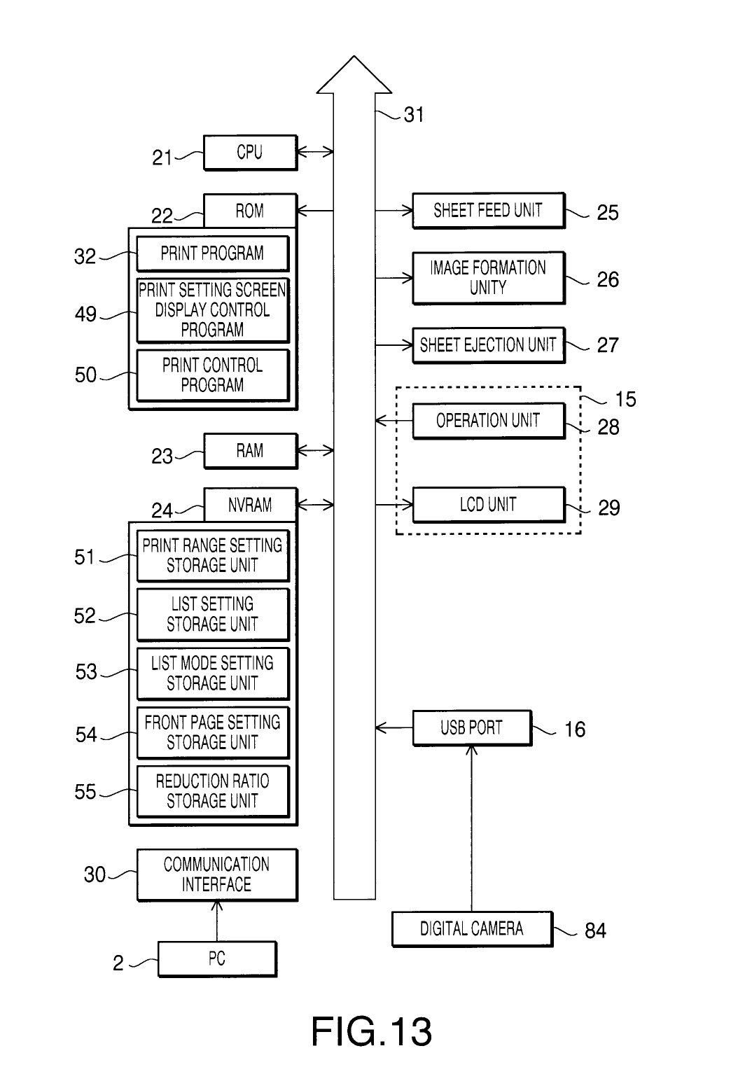

In the following, a print control device, a printing device and a print control program in accordance with a second embodiment of the present invention will be described. FIG. 13 is a block diagram showing the electrical configuration of a printer 3 as an example of the “printing device” in accordance with the second embodiment and the overall composition of a print control device 85 included in the printer 3.

The print control device 85 in the second embodiment differs from the print control device 40 in the first embodiment in that the print control device 85 is included not in the PC 2 but in the printer 3. Thus, the following description will be given mainly on the difference from the first embodiment, wherein reference characters identical or similar to those used in the first embodiment represent elements identical or equivalent to those in the first embodiment and repeated explanation of such elements will be omitted properly.

<Electrical Configuration of Printer>

As shown in FIG. 13, storage areas such as a print range setting storage unit 51, a list setting storage unit 52, a list mode setting storage unit 53, a front page setting storage unit 54 and a reduction ratio storage unit 55 are reserved in the NVRAM 24 of the printer 3 in the second embodiment. A print setting screen display control program 49 and a print control program 50 are stored in the ROM 22 of the printer 3. In the printer 3 in the second embodiment, the print control device 85 is formed by the CPU 21, the ROM 22, the RAM 23, the NVRAM 24, the storage units reserved in the NVRAM 24 (print range setting storage unit 51, list setting storage unit 52, list mode setting storage unit 53, front page setting storage unit 54, reduction ratio storage unit 55), and the print setting screen display control program 49 and the print control program 50 stored in the ROM 22.

Since the amount of data that can be displayed on the LCD unit 29 of the printer 3 (displaying only two lines) is far smaller compared to the liquid crystal display 8 of the PC 2, the print setting screen display control program 49 of the printer 3 displays the setting items of the basic setting screen 61 (FIG. 7) and the list print setting screen 71 (FIG. 8) by segmenting them into several groups.

While the print control program 50 in the first embodiment executed the printing process for “print data” by outputting the “print data” from the PC 2 to the printer 3, the print control program 50 in the second embodiment outputs the “print data” to the print program 32 as the printing process for the “print data”.

<Method of Setting Print Conditions>

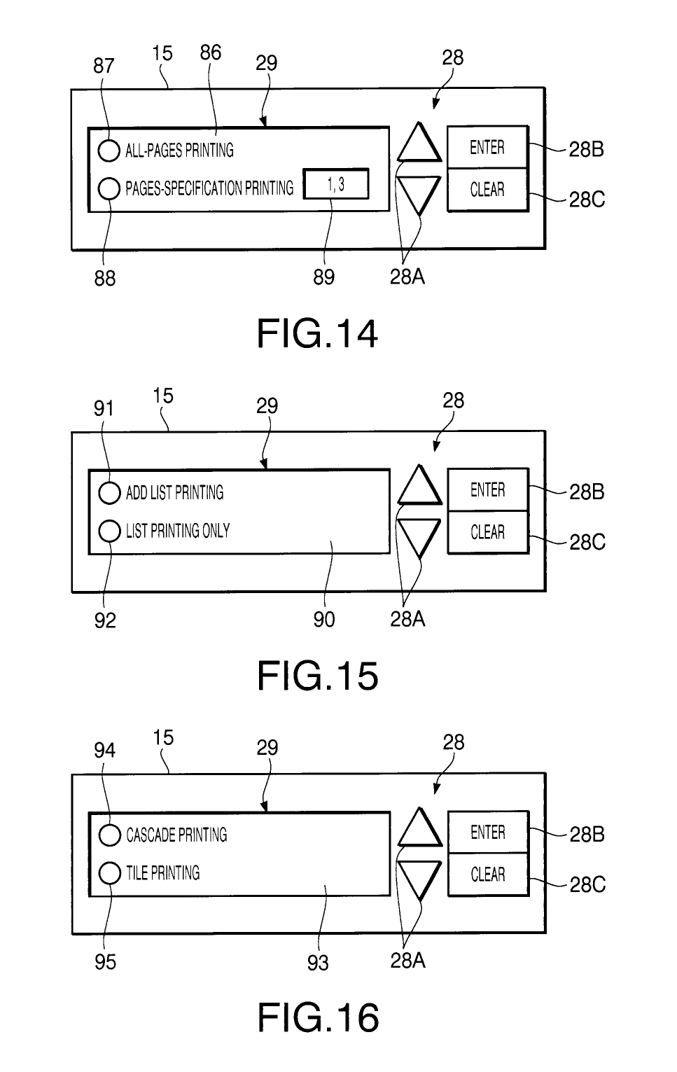

As shown in FIG. 14, the operation panel 15 of the printer 3 includes the LCD unit 29 and the operation unit 28 which are placed side by side. The operation unit 28 includes scroll buttons 28A, an ENTER button 28B for finalizing data setting/input, and a CLEAR button 28C for deleting data.

When the printer 3 reads out data from a digital camera 84 connected to the USB port 16, for example, and executes the printing of the data, the printer 3 displays a print condition setting screen on the LCD unit 29 and thereby lets the user set the print conditions. FIGS. 14-18 are schematic diagrams showing examples of the print condition setting screen.

For example, the user calls up a basic setting screen 86 shown in FIG. 14 on the LCD unit 29 by operating the scroll buttons 28A. The basic setting screen 86 includes an all-pages printing radio button 87 for setting the all-pages printing parameter as the “print range setting” stored in the print range setting storage unit 51, a page-specification printing radio button 88 for setting the page-specification printing parameter as the “print range setting”, and a print page specification window 89 for specifying page numbers of the pages to be printed when the page-specification printing radio button 88 has been selected.

When the user presses the ENTER button 28B after setting the above print condition (print range) on the basic setting screen 86 by operating the scroll buttons 28A, the CPU 21 of the printer 3 displays a list setting screen 90 shown in FIG. 15 on the LCD unit 29. The list setting screen 90 includes an add-list check box 91 for setting the add-list parameter as the “list setting” stored in the list setting storage unit 52 and a list-only check box 92 for setting the list-only parameter as the “list setting”.

When the user presses the ENTER button 28B after setting the above print condition (list setting) on the list setting screen 90 by operating the scroll buttons 28A, the CPU 21 of the printer 3 displays a list mode setting screen 93 shown in FIG. 16 on the LCD unit 29. The list mode setting screen 93 includes a cascade printing radio button 94 for setting the cascade display parameter as the “list mode setting” stored in the list mode setting storage unit 53 and a tile printing radio button 95 for setting the tile display parameter as the “list mode setting”.

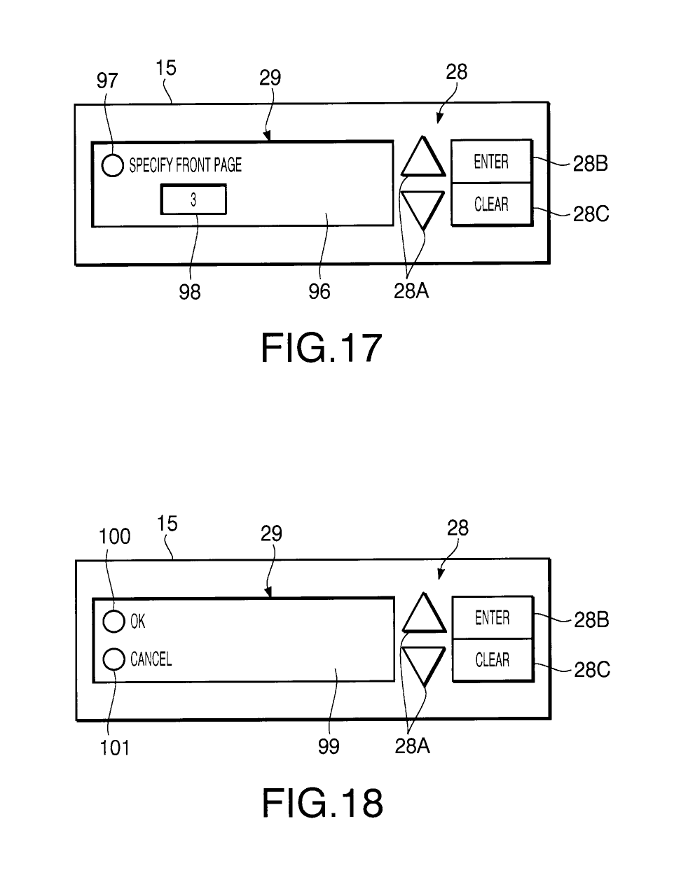

When the user presses the ENTER button 28B after setting the above print condition (list mode setting) on the list mode setting screen 93 by operating the scroll buttons 28A, the CPU 21 of the printer 3 displays a front page setting screen 96 shown in FIG. 17 on the LCD unit 29. The front page setting screen 96 includes a front page setting radio button 97 for setting the front page specification parameter as the “front page setting” stored in the front page setting storage unit 54 and a front page specification window 98 for specifying the page to be handled as the front page.

When the user presses the ENTER button 28B after setting the above print condition (front page setting) on the front page setting screen 96 by operating the scroll buttons 28A, the CPU 21 of the printer 3 displays a setting completion screen 99 shown in FIG. 18 on the LCD unit 29. The setting completion screen 99 includes an OK radio button 100 for completing the print condition setting and a CANCEL radio button 101 for canceling the print condition setting. After setting the parameter of the “print range setting” (regarding the normal printing) and the parameters of the “list setting”, “list mode setting” and “front page setting” (regarding the list printing), the user selects the OK radio button 100 by use of the operation unit 28, by which the parameters are stored in the storage areas of the NVRAM 24 (print range setting storage unit 51, list setting storage unit 52, list mode setting storage unit 53, front page setting storage unit 54), replacing previously set parameters.

<Printing Operation>

The printing operation of the printer 3 in the second embodiment will be described below. When the CPU 21 of the printer 3 executes the printing of data stored in the digital camera 84 connected to the USB port 16 by reading out the data from the digital camera 84, the CPU 21 loads the print control program 50 from the ROM 22 into the RAM 23 and executes the program 50 in response to the reception of the data from the digital camera 84 as a trigger. The CPU 21 executing the print control program 50 generates the “normal print data” for the data read out from the digital camera 84 in regard to each page specified by the “print range setting”. In cases where the list printing is executed, the CPU 21 generates the “processing image data” based on the “normal print data” and temporarily stores the “processing image data” in the RAM 23.

After finishing the normal printing process, the CPU 21 generates the “cascade print data” by reducing each page (“processing image data”) according to the layout information (reduction ratios Kx and Ky) and successively placing (overlaying) the pages on one sheet while shifting each page from the previous page. Thereafter, the CPU 21 supplies the generated “cascade print data” to the print program 32. The print program 32 makes the image formation unit 26 print the “cascade print data” on a sheet fed from the sheet feed tray 12 by the sheet feed unit 25 and makes the sheet ejection unit 27 eject the printed sheet to the output tray 14.

In cases where no front page has been specified on the front page setting screen 96 shown in FIG. 17 and the page-specification printing (specifying pages to be printed) has not been specified on the basic setting screen 86 shown in FIG. 14, a cascade printout like the one shown in FIG. 10, placing the last page EP at the forefront, is obtained.

In cases where the front page setting radio button 97 on the front page setting screen 96 shown in FIG. 17 has been selected and the front page to be placed at the forefront (e.g. page 3) has been specified in the front page specification window 98, a cascade printout like the one shown in FIG. 11, placing the front page PR (e.g. page 3) at the forefront, is obtained.

In cases where the page-specification printing radio button 88 on the basic setting screen 86 shown in FIG. 14 has been selected and the pages as the objects of the page-specification printing (e.g. pages 1 and 3) have been specified in the print page specification window 89, a cascade printout like the one shown in FIG. 12, placing the specified pages SP (e.g. pages 1 and 3) at the front and the other pages at the rear, is obtained.

As above, the print control device 85 in the second embodiment (included in the printer 3) achieves the same effects as the print control device 40 in the first embodiment (included in the PC 2).

Further, the printer 3 equipped with the print control device 85 is capable of carrying out the cascade printing (of multiple pages included in one job) in units of pages on a sheet, according to the “cascade print data” generated by the print control device 85 included therein. With the printer 3 originally equipped with the print control device 85, the user is allowed to use the cascade printing function in units of pages, without the trouble of installing the print control program 50 in the PC 2.

While a description has been given above of preferred embodiments in accordance with the present invention, the present invention is not to be restricted by the particular illustrative embodiments and a variety of modifications, design changes, etc. are possible without departing from the scope and spirit of the present invention described in the appended claims.

(1) For example, while a printer 3 has been described as an example of the “printing device” in the above embodiments, the present invention is applicable to any type of “printing device” (device having the printing function), such as MFPs (Multi-Function Peripherals) and copy machines.

(2) While the print control program 50 in the first embodiment is installed in the PC 2 from a recording medium (e.g. CD-ROM 18) storing the program 50, it is also possible to let the PC 2 automatically download the print control program 50 from the printer 3 upon connection of the printer 3 to the PC 2.

(3) While the cascade printing in the above embodiments is carried out by successively overlaying (arranging) the reduced pages (“processing image data”) on one sheet in an oblique direction from the upper left to the lower right of the sheet, the successive overlaying of the pages in the cascade printing may also be done from the lower right to the upper left, from the lower left to the upper right, or from the upper right to the lower left. Further, the successive overlaying may also be done in the vertical direction, in the horizontal direction, or in two or more lines (cascades). In other words, the direction of the successive overlaying (cascade) and the number of cascades are not particularly limited. Furthermore, while the successive overlaying of the pages for the cascade printing is carried out from the first page to the last page in the above embodiments, the order of the successive overlaying may also be reversed (from the last page to the first page).

(4) While the cascade printing is executed by generating the “cascade print data” after the completion of the normal printing (the printing of the “normal print data” while receiving the “incoming data” supplied page by page) in the above embodiments, the cascade printing by the execution of the print control program 50 (e.g. FIG. 5) is also possible even when the printing of the “normal print data” is carried out after receiving all the pages included in one file and recognizing the total number of pages to be printed. Thus, both cases (a printing process while receiving the “incoming data” page by page and a printing process after receiving the “incoming data” of all pages) can be handled by the same print control program 50.

What is claimed is:

1. A print control device comprising a print data generating unit which generates print data from incoming data that includes a job containing a plurality of pages,
wherein the print data generating unit includes:
a layout information generating unit which generates layout information specifying layout in a printable area based on sheet size and the number of pages of the job;
a memory that stores an image to be formed on a sheet; and
an arrangement unit which generates cascade print data by reducing each page of the job and successively placing and overlaying the reduced pages in the memory corresponding to the sheet size based on the layout information generated by the layout information generating unit.

2. The print control device according to claim 1,
wherein the layout information includes reduction ratio to be used for reducing each page of the job and horizontal and vertical shift amounts to be used for horizontally and vertically shifting each page from the previous page in the successive placing and overlaying of the reduced pages in the memory.

3. The print control device according to claim 1,
further comprising a front page specification unit which specifies a front page, as a page to be placed at the forefront of the pages successively placed and overlaid in the memory, from the pages contained in the job,
wherein the arrangement unit executes the placing and overlaying of the front page specified by the front page specification unit at the last.

4. The print control device according to claim 1,
wherein the print data generating unit further includes a page print data generating unit which generates page print data in which one page included in the job is placed in the memory, and
wherein the arrangement unit executes the placing and overlaying of the pages corresponding to the page print data at the last in cases where the generation of the page print data is carried out by the page print data generating unit.

5. The print control device according to claim 4,
further comprising a selection unit which selects normal printing, as printing according to normal print data in which each page included in the job is placed in the memory, and/or cascade printing, as printing according to the cascade print data generated by the arrangement unit.

6. The print control device according to claim 1, wherein the incoming data is data read out from a detachable external memory.

7. The print control device according to claim 1, wherein the incoming data is data received from an application.

8. A printing device comprising a print control device including a print data generating unit which generates print data from incoming data that includes a job containing a plurality of pages, and a memory that stores image data generated from the pages of the job, wherein the print data generating unit includes:
a layout information generating unit which generates layout information specifying layout in a printable area based on sheet size and the number of pages of the job; and
an arrangement unit which generates cascade print data by reducing each page of the job and successively placing and overlaying the reduced pages on the memory corresponding to the sheet size based on the layout information generated by the layout information generating unit.

9. A computer-readable recording medium storing computer-readable instructions that cause a computer to execute a print data generating process of generating print data in in a memory from incoming data that includes a job containing a plurality of pages, wherein the print data generating process includes:
a layout information generating step of generating layout information specifying layout in a printable area based on sheet size and the number of pages of the job; and
an arrangement step of generating cascade print data by reducing each page of the job and successively placing and overlaying the reduced pages in the memory corresponding to the sheet size based on the layout information generated by the layout information generating step.

10. The computer-readable recording medium according to claim 9,
wherein the layout information includes reduction ratio to be used for reducing each page of the job and horizontal and vertical shift amounts to be used for horizontally and vertically shifting each page from the previous page in the successive placing and overlaying of the reduced pages.

11. The computer-readable recording medium according to claim 9,
further storing computer-readable instructions that cause the computer to execute a front page specification step of specifying a front page, as a page to be placed at the forefront of the pages successively placed and overlaid in the memory, from the pages of the job,
wherein the arrangement step executes the placing and overlaying of the front page specified by the front page specification step at the last.

12. The computer-readable recording medium according to claim 9,
wherein the print data generating process further includes a page print data generating step of generating page print data in which one page included in the job is placed in the memory, and
wherein the arrangement step executes the placing and overlaying of the pages corresponding to the page print data at the last in cases where the generation of the page print data is carried out by the page print data generating step.

13. The computer-readable recording medium according to claim 12,
further comprising a selection step of selecting normal printing, as printing according to normal print data in which each page included in the job is placed in the memory, and/or cascade printing, as printing according to the cascade print data generated by the arrangement step.

14. The computer-readable recording medium according to claim 9, wherein the incoming data is data read out from a detachable external memory.

15. The computer-readable recording medium according to claim 9, wherein the incoming data is data received from an application.
